(19) United States
(12) Patent Application Publication
(10) Pub. No.: US 2007/0107580 A1
(43) Pub. Date: May 17, 2007

(54) Friction torque capo

(76) Inventor: Johannes Hubertus Leonardus Vleugels, Landgraaf (NL)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/281,337

(22) Filed: Nov. 17, 2005

(51) Int. Cl. G10D 3/04

(52) U.S. Cl. 84/308

(57) ABSTRACT

A friction capo includes a first hinged arm and a second hinged arm coupled together by a friction hinge. The friction hinge includes a rotatable shaft and a friction element mounted on the shaft. The first hinged arm is coupled to the shaft and the second hinged arm is coupled to the friction element. The friction element is placed over the shaft such that the shaft frictionally engages the friction element. The capo has a holding torque configured to hold strings of an instrument firmly against a fret board.

### BACKGROUND

The present invention relates to a capo. The capo is configured with a friction torque hinge for controlling opening and closing.

A capo is a well-known movable bar attached to the fingerboard or fret board of a fretted instrument to uniformly raise the pitch of all the strings. Capos are typically used by musicians who play guitars and other stringed instruments to easily change music keys. In effect, a capo will simultaneously finger all the strings at a single fret as long as the capo is secured in place. This sets the half-notes sounded when the open strings are strummed. In this way, playing the guitar at a half-note increase is simplified without compromising the original string composition. Capos are in widespread use as a result, and there are many screw-down and clamp-down versions being sold commercially.

One particular type of capo is a levered clamp with separate rubber linings on the inside of the two jaws, commonly called a “C-clamp” capo. In such a C-clamp design, a frame with a straight rubber facing is clamped down tight over the strings of a guitar and pulls them against the fret board. An idler clamp with a concave curve and a short rubber facing presses from behind the fret board. Typically, a hinge or locking lever couples the two in order to hold the strings down tightly.

Typically, in its closed position on the fret board, the capo must exert enough force such that the strings are held sufficiently firmly against the fret board. Then, the capo is typically configured to be disengaged so that it can be removed from the guitar so that its strings return to normal pitch. Consequently, many capos include some sort of locking mechanism with some sort of associated release mechanism.

For these and other reasons, there is a need for the present invention.

### SUMMARY

The present invention is a friction capo. The friction capo includes a first hinged arm and a second hinged arm coupled together by a friction hinge. The friction hinge includes a rotatable shaft and a friction element mounted on the shaft. The first hinged arm is coupled to the shaft and the second hinged arm is coupled to the friction element. The friction element is placed over the shaft such that the shaft frictionally engages the friction element. The capo has a holding torque configured to hold strings of an instrument firmly against a fret board.

In one embodiment, the torque of the capo increases as an increased number of friction elements are mounted on the shaft.

### BRIEF DESCRIPTION OF THE DRAWINGS

FIG. 1 illustrates a perspective view of one embodiment of a friction capo in accordance with the present invention.

FIG. 2 illustrates an exploded view of one embodiment of a friction capo in accordance with the present invention.

FIG. 3 illustrates a cross-sectional end view of one embodiment of a friction capo in accordance with the present invention.

FIG. 4 illustrates a partial side view, with a portion ghosted, of one embodiment of a friction capo in accordance with the present invention.

FIG. 5 illustrates an alternative embodiment of a friction hinge for a friction capo in accordance with the present invention.

FIG. 6 illustrates an alternative embodiment of a friction hinge for a friction capo in accordance with the present invention.

FIG. 7 illustrates an alternative embodiment of a friction hinge for a friction capo in accordance with the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

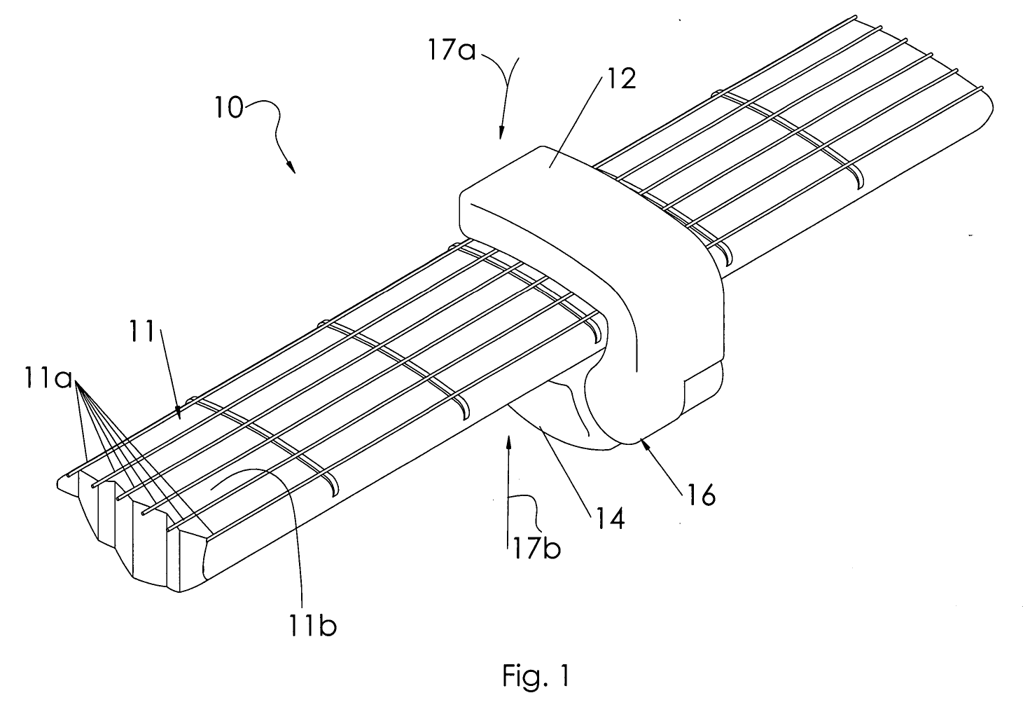

FIG. 1 illustrates a perspective view of friction capo 10 in accordance with one embodiment of the present invention. In FIG. 1, capo 10 is illustrated placed over an exemplary stringed instrument 11. Strings 11a and fret board 11b are also illustrated. Capo 10 includes barre 12, back arm 14, and friction hinge 16. In one embodiment, capo 10 is configured to be attachable to the neck of a guitar or other stringed instrument 11 in order to firmly hold strings 11a of the instrument 11 against a fret board 11b. No lock or release mechanism is needed to engage or disengage capo 10 from the instrument.

In operation of one embodiment, capo 10 is attached to the neck of stringed instrument 11 by applying a closing force relative to barre 12 and back arm 14 such that they are forced toward each other. In this way, the closing force is applied in the direction of arrows 17a and 17b to barre 12 and back arm 14, respectively. This closing force is applied until the strings 11a of instrument 11 are firmly held against fret board 11b. A holding torque within friction hinge 16 then holds capo 10 in this closed position such that strings 11a continue to be firmly held against fret board 11b, even after the closing force is removed.

Then, capo 10 is released from the neck of instrument 11 by applying an opening force relative to barre 12 and back arm 14 such that they are forced away from each other. In this way, the opening force is applied in the direction opposite arrows 17a and 17b to barre 12 and back arm 14, respectively. In one case, the opening force is at least slightly more than the holding torque within friction hinge 16. Thus, the opening force overcomes the holding torque such that capo 10 opens and releases the neck of the stringed instrument 11.

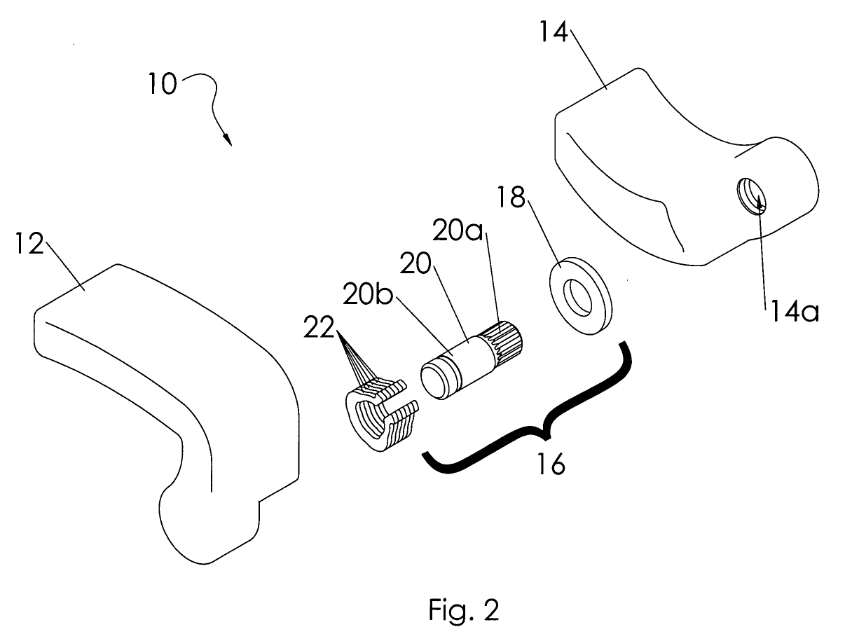

FIG. 2 illustrates an exploded view of friction capo 10 in accordance with one embodiment of the present invention. Capo 10 includes barre 12, back arm 14, and friction hinge 16. Friction hinge 16 is illustrated in exploded view so that further components of friction hinge 16 are visible. In one embodiment, friction hinge 16 includes washer 18, shaft 20 and a plurality of friction elements 22. Shaft 20 has a first end 20a and a middle portion 20b. In one embodiment, friction hinge 16 and its components establish the holding torque for capo 10.

In one embodiment, each of the plurality of friction elements 22 is placed over shaft 20 at its middle portion 20b when capo 10 is fully assembled. In one case, the plurality of friction elements 22 are each configured such that they have an inner opening for receiving shaft 20 in such a way that they frictionally engage shaft 20. In one example, the plurality of friction elements 22 each have an inner opening with a relaxed diameter that is less than the diameter of shaft 20 at its middle portion 20b where friction elements 22 are each placed. In this way, when friction elements 22 are placed over the larger diameter of shaft 20, they are frictionally engaged therewith. In one case, it is this frictional engagement that contributes to the holding torque within friction hinge 16.

In one embodiment, shaft 20 is further provided with a groove in the shaft proximate to an edge of middle portion 20b. In this way, one of the plurality of clips 22 can be placed within the groove when capo 10 is fully assembled. Washer 18 is then press fit on an opposite edge of middle portion 20b of shaft 20. Washer 18 is then configured to be press fit to, or otherwise held within, barre 12. In this way, capo 10 is held together in the axial direction, that is, the direction in which shaft 20 extends. In this way, it will not tend to pull apart axially with use. As an alternative to the groove in shaft 20, a washer can be press fit on either side of friction elements 22. Various other known methods for axial containment can be used as well.

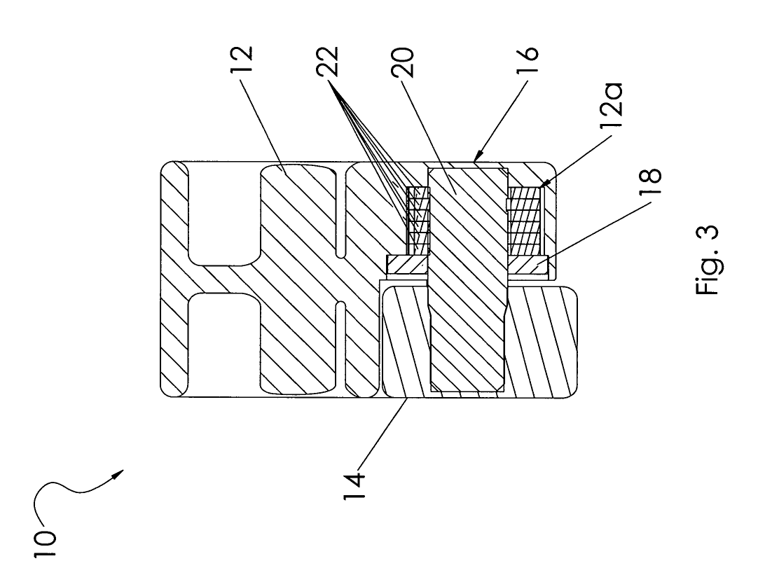

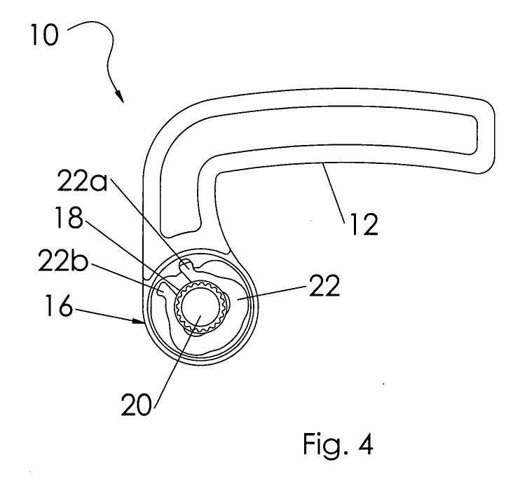

FIGS. 3 and 4 respectively illustrate cross-sectional end and partial side views of capo 10 in accordance with one embodiment of the present invention. In FIGS. 3 and 4, capo 10 is illustrated fully assembled. In FIG. 4, a portion of friction hinge 16 of capo 10 is ghosted so that its internal components are visible.

In one embodiment, shaft 20 has an end portion 20a with raised tangs. End portion 20a is then coupled within hole 14a of back arm 14. In this way, shaft 20 is fixed to back arm 14 such that shaft 20 does not rotate relative to back arm 14. In the same way, rotation of back arm 14 also rotates shaft 20. Also in one embodiment, the plurality of friction elements 22 are each contained within a slot 12a of barre 12. In one case, the friction elements 22 have an outer profile that engages the shape of slot 12a such that the plurality of friction elements 22 do not rotate relative to barre 12. In the same way, rotation of barre 12 also rotates the plurality of friction elements 22.

Consequently, the rotation of barre 12 relative to back arm 14 causes the rotation of shaft 20 within friction elements 22. Since the friction elements 22 are pressed on to shaft 20, when they are rotated relative to each other the interference between the friction elements 22 and shaft 20 provides, in one case, a constant static and dynamic torque.

In one embodiment, the number of friction elements 22 that are placed over shaft 20 can be varied, thereby varying the amount of torque produced by the relative rotation of friction elements 22 and shaft 20 and varying the holding torque of capo 10. The holding toque of capo 10 is increased by the addition of friction elements 22, and decreased by their subtraction. In this way, the number of friction elements 22 placed over shaft 20 can be selected based on the desired holding torque for the application.

For example, for a variety of stringed instruments, there will be a certain amount of force required to push and hold strings 11a of instrument 11 firmly against fret board 11b of instrument 11. This “spring back force” from strings 11a being stretched above fret board 11b will tend to move strings 11a away from the fret board 11b (in the direction opposite 17a in FIG. 1) as they are pushed toward it by barre 12. In one case, the number of the friction elements 22 used is such that that holding torque of capo 10 is sufficiently high to overcome the spring back force of the stringed instrument 11. In this way, when the user applies a closing force on barre 12 and back arm 14 in order to close capo 10 on a stringed instrument 11, the holding torque of capo 10 is sufficiently high to overcome the spring back force of strings 11a, thereby allowing barre 12 to hold strings 11a firmly against the fret board 11b, even after the closing force is removed from capo 10. In order to remove capo 10, an opening force greater than the holding torque of capo 10 is applied to barre 12 and back arm 14, thereby opening capo 10 off the stringed instrument 11. No independent release mechanism is needed to allow barre 12 and back arm 14 to be separated.

In one embodiment, capo 10 exhibits a different amount of torque in opening than it does in closing. In such case, relatively low torque is needed in closing capo 10 and pressing the strings 11a of the instrument 11 against the fret board 11b. A relatively higher torque is needed to remove capo 10. In such an embodiment, capo 10 also has a relatively high holding torque that will firmly hold the strings 11a down and counteract the spring back force of the strings 11a, which tends to push back.

In one embodiment, this differing torque is achieved by providing a friction element 22 configured with first and second toes 22a and 22b, as illustrated in FIG. 4. Then, rather than have the profile of the friction elements 22 engage the entire slot 12a in order to prevent relative rotation of friction elements 22 and slot 12a, only first toe 22a is configured to engage a recessed portion of slot 12a, such a groove as illustrated in FIG. 4. In this way, when barre 12 and back arm 14 are pressed closed, first toe 22a, which engages the recessed portion of slot 12a, will tend to “wrap open” or tend to pull away from shaft 20 such that torque is slightly decreased. Conversely, when barre 12 and back arm 14 are pressed open, toe 22a will tend to “wrap down” or slightly push down on shaft 20 such that torque is slightly increase. One skilled in the art will understand that various other techniques and configurations of friction elements 22 can be used to produce different torque in rotation directions, or symmetrical torque in both rotation directions.

In one embodiment, friction elements 22 are each configured to be relatively flat members. In other words, the dimension of friction elements 22 in an axial direction, that is, the direction in which shaft 20 extends, is significantly less than the dimension of friction elements 22 in the direction perpendicular to the axial direction. In this way, the outer profile of each of the friction elements 22 is substantially larger than the radial thickness of each of the friction elements 22. As a result, friction elements 22 are easily added or subtracted from the design of capo 10 in order to achieve the desired torque properties without substantially changing the overall package design.

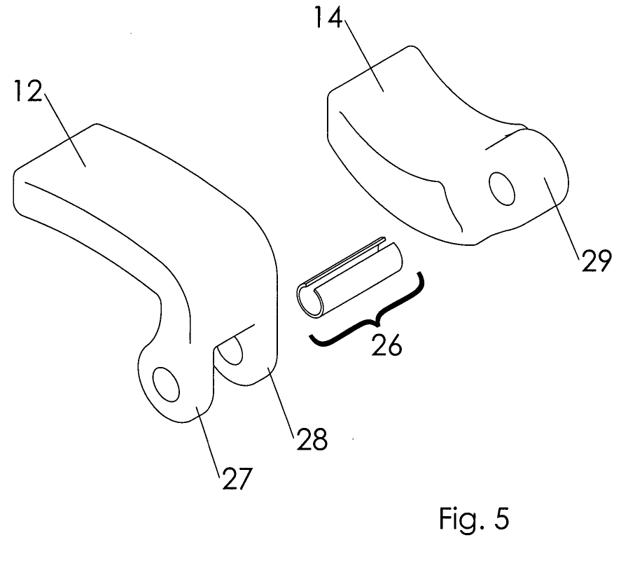

FIG. 5 illustrates an alternative embodiment of a friction hinge 26 for a friction capo, such as friction capo 10, in accordance with the present invention. For example, friction hinge 26 can be coupled between barre 12 and back arm 14, in place of friction hinge 16, in order to provide the holding torque that holds capo 10 in its closed position. In the illustrated example, friction hinge 26 is a roll pin. Barre 12 is then provided with first and second barre flanges 27 and 28, and back arm 14 is provided with arm flange 29. In this way, when the capo is assembled, arm flange 29 is placed between first and second barre flanges 27 and 28, and friction hinge 26 is inserted in slot provided in each of the flanges 27, 28 and 29 of barre 12 and back arm 14. One or both ends can be configured to be frictionally engaged in the slot so that it can slip as force is applied relative to barre 12 and back arm 14, thereby providing the holding torque.

In this alternative embodiment, friction capo 10 operates as described above. In this way, capo 10 is attached to the neck of stringed instrument 11 by applying the closing force relative to barre 12 and back arm 14 such that they are forced toward each other in the direction of arrows 17a and 17b, until strings 11a are firmly held against fret board 11b. The holding torque of friction hinge 26 holds capo 10 in this closed position such that strings 11a continue to be firmly held against fret board 11b, even after the closing force is removed. Capo 10 is released from the neck of instrument 11 by applying the opening force relative to barre 12 and back arm 14 such that they are forced away from each other.

In this alternative embodiment using friction hinge 26, the holding torque can be varied by adjusting the size of the holes within flanges 27, 28, and 29 of barre 12 and back arm 14 into which friction hinge 26 is received, adjusting the thickness of the roll pin, as well as various other modifications. As long as the holding torque is greater than the spring back force of strings 11a, and is overcome by the opening and closing forces, capo 10 will operate properly. In this alternative embodiment, placing arm flange 29 between first and second barre flanges 27 and 28 provides axial containment, but other methods, such as those discussed above and others, can be used for axial containment as well.

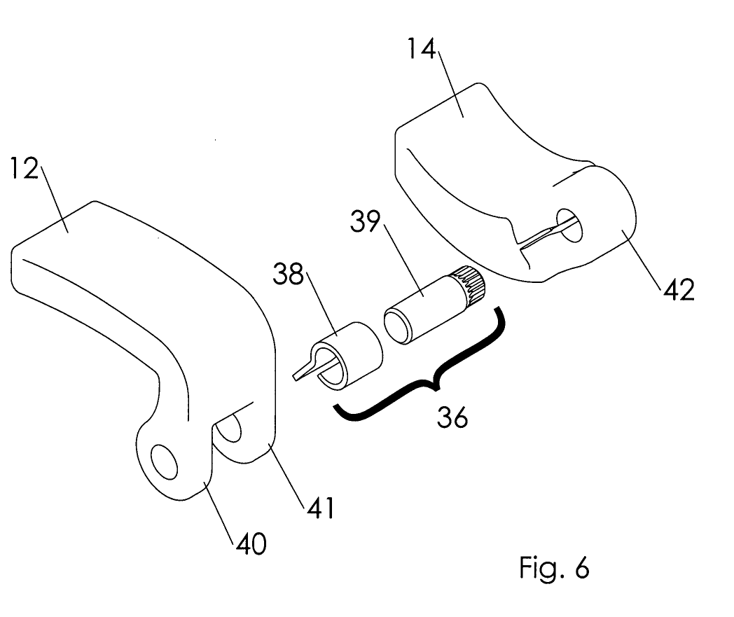

FIG. 6 illustrates an alternative embodiment of a friction hinge 36 for a friction capo, such as friction capo 10 in FIGS. 1-4, in accordance with the present invention. For example, friction hinge 36 can be coupled between barre 12 and back arm 14, in place of friction hinge 16, in order to provide the holding torque that holds capo 10 in its closed position. In the illustrated example, friction hinge 36 is an elongated friction element 38 that is fitted over a shaft 39. Barre 12 is then provided with first and second barre flanges 40 and 41, and back arm 14 is provided with arm flange 42. In this way, when the capo is assembled, arm flange 42 is placed between first and second barre flanges 40 and 41, and friction hinge 36 is inserted in slot provided in each of the flanges 40, 41 and 42 of barre 12 and back arm 14.

Shaft 39 has an end with raised tangs that is inserted into a slot within flange 41 of back arm 14, and elongated friction element 38 is inserted within a slot and adjacent slit in arm flange 42 of back arm 14. In this way, shaft 39 is fixed to barre 12 via the raised tangs such that shaft 39 does not rotate relative to barre 12. Similarly, elongated friction element 38 is configured to engage back arm 14 such that elongated friction element 38 does not rotate relative to back arm 14. Finally, elongated friction element 38 is configured to contain and frictionally engage shaft 39.

Consequently, the rotation of barre 12 relative to back arm 14 causes the rotation of shaft 39 within elongated friction element 38. Since elongated friction element 38 frictionally engages shaft 39, when they are rotated relative to each other the interference between them provides the holding torque.

In this alternative embodiment using friction hinge 36, the holding torque can be varied by adjusting the inner diameter of elongated friction element 38 and/or the outer diameter of shaft 39, thereby adjusting the amount of interference between them. Various other modifications can be used as well to adjust the holding torque. As with the other designs above, as long as the holding torque is greater than the spring back force of strings 11a, and is overcome by the opening and closing forces, capo 10 will operate properly. In this alternative embodiment, placing arm flange 42 between first and second barre flanges 40 and 41 provides axial containment, but other methods, such as those discussed above and others, can be used for axial containment as well.

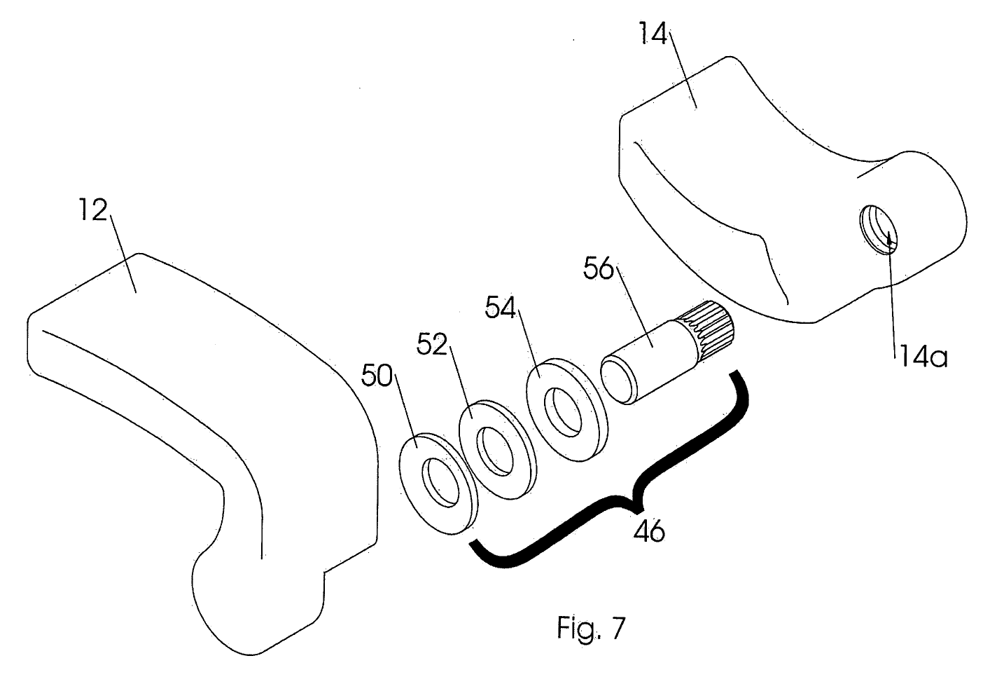

FIG. 7 illustrates an alternative embodiment of a friction hinge 46 for a friction capo, such as friction capo 10, in accordance with the present invention. For example, friction hinge 46 can be coupled between barre 12 and back arm 14, in place of friction hinge 16 in FIGS. 1-4, in order to provide the holding torque that holds capo 10 in its closed position. In the illustrated example, friction hinge 46 is a Bellville washer 50, a first flat washer 52 and a second flat washer 54, which are all placed over a shaft 56. First flat washer 52 is press fit over shaft 56 such that they rotate together. Shaft 56 has an end with raised tangs that is inserted into a slot within back arm 14. In this way, shaft 56 is fixed to back arm 14 such that shaft 56 does not rotate relative to back arm 14.

Second flat washer 54 is press fit, or otherwise coupled within, barre 12 in such a way that all three washers 50, 52 and 54 are axially compressed. In this way, Bellville washer 50 and second flat washer 54 are configured to be fixed to barre 12 such that they do not rotate relative to barre 12. With the axial compression, Bellville washer 50 pushes against first and second flat washers 52 and 54 in the axial direction such that they frictionally engage each other.

Consequently, the rotation of barre 12 relative to back arm 14 causes the surfaces of first and second flat washers 52 and 54 to engage their respective surfaces. Since washers 50, 52, and 54 are all axially compressed, and thus, frictionally engaged, when they are rotated relative to each other the interference between them provides the holding torque.

In this alternative embodiment using friction hinge 46, the holding torque can be varied by adjusting the amount of axial compression, and the overall size and/or rigidity of the washers, thereby adjusting the amount of interference between them. Various other modifications can be used as well. As with the other designs above, as long as the holding torque is greater than the spring back force of strings 11a, and is overcome by the opening and closing forces, capo 10 will operate properly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A friction capo configured to hold strings of an instrument against a fret board, the capo comprising:
a first arm;
a second arm; and
a friction hinge component coupling the first and second arms such that each is rotatable relative to the other;
wherein the friction hinge is configured with a holding torque greater than a spring back force of the strings such that the first arm firmly holds the strings against the fret board.

2. The friction capo of claim 1, wherein the friction hinge further comprises a rotatable shaft coupled to the first hinged arm and a plurality of friction elements mounted on the shaft and engaging the second arm, and wherein the shaft frictionally engages the friction elements.

3. The friction capo of claim 2, wherein the plurality of friction elements are configured to engage the second arm such that they do not rotate relative thereto, and wherein the holding torque is produced by the frictional engagement between the shaft and the friction elements.

4. The friction capo of claim 2, wherein the holding torque is proportional to the number of frictional elements mounted over the shaft.

5. The friction capo of claim 2, wherein each of the friction elements has an outer profile and a radial thickness and wherein the outer profile of each of the friction elements is substantially larger than the radial thickness of each of the friction elements.

6. The friction capo of claim 2, wherein the holding torque is increase by increasing the number of frictional elements mounted over the shaft.

7. The friction capo of claim 1, wherein the friction hinge further comprises a roll pin with a first and a second end, wherein the first end is frictionally coupled to the first hinged arm and second end is coupled to the second hinged arm, and wherein the holding torque is produced by the frictional engagement between the shaft and one of the first and second arms.

8. The friction capo of claim 1, wherein the friction hinge further comprises a solid shaft coupled to the first hinged arm and an elongated friction element mounted on the shaft and engaging the second arm, wherein the shaft frictionally engages the elongated friction element, and wherein elongated friction element is configured to engage the second arm such that it does not rotate relative thereto, and wherein the holding torque is produced by the frictional engagement between the shaft and the elongated friction element.

9. The friction capo of claim 1, wherein the friction hinge further comprises a solid shaft coupled to the first hinged arm and a plurality of washers mounted over the shaft at least one of which engages the second arm, wherein the washers are axially compressed such that the holding torque is produced by the frictional engagement between frictional engagement of their surfaces.

10. The friction capo of claim 1, wherein the holding torque is different when the first arm is rotated toward the second arm that it is when the first arm is rotated away from the second arm.

11. The friction capo of claim 1, wherein the holding torque is less when the first arm is rotated toward the second arm that it is when the first arm is rotated away from the second arm.

12. A friction capo comprising:
a first hinged arm;
a rotatable shaft coupled to the first hinged arm;
a plurality of friction elements mounted on the shaft such that the shaft frictionally engages the friction elements; and
a second hinged arm engaging the friction elements;
wherein rotation of the first hinged arm relative to the second hinged arm produces a holding torque caused by an interference between the friction elements and the shaft.

13. The friction capo of claim 12, wherein the holding torque is less when the first arm is rotated toward the second arm that it is when the first arm is rotated away from the second arm.

14. The friction capo of claim 13, wherein the friction elements are configured with first and second toes, and wherein the first toe of at least some of the friction elements engage the second hinged arm such that the holding torque is less when the first arm is rotated toward the second arm than it is when the first arm is rotated away from the second arm.

15. The friction capo of claim 12, wherein the holding torque is proportional to the number of frictional elements mounted over the shaft.

16. The friction capo of claim 12, wherein each of the friction elements has an outer profile and a radial thickness and wherein the outer profile of each of the friction elements is substantially larger than the radial thickness of each of the friction elements.

17. The friction capo of claim 12, wherein the holding torque is increase by increasing the number of frictional elements mounted over the shaft.

18. The friction capo of claim 10 further configured to hold strings of an instrument against a fret board, wherein the holding torque is greater than a spring back force of the strings such that the first arm firmly holds the strings against the fret board.
